(19) United States
(12) Patent Application Publication
(10) Pub. No.: US 2026/0230471 A1
(43) Pub. Date: Aug. 6, 2026

(54) VEHICLE, BACK-END SYSTEM, AND AUTOMATED VALET PARKING SYSTEM

(71) Applicant: TOYOTA JIDOSHA KABUSHIKI KAISHA, Toyota-shi (JP)

(72) Inventors: Tatsuya SUGANO, Seto-shi (JP); Hidenobu KINUGASA, Nagoya-shi (JP); Takahiro YAMAMOTO, Toyota-shi (JP); Kazuhito ESHIMA, Toyota-shi (JP)

(73) Assignee: TOYOTA JIDOSHA KABUSHIKI KAISHA, Toyota-shi (JP)

(21) Appl. No.: 19/407,564

(22) Filed: Dec. 3, 2025

(30) Foreign Application Priority Data
Feb. 3, 2025 (JP) 2025-016130

(51) Int. Cl. H04L 9/40; H04W 4/44; H04W 12/069

(52) U.S. Cl. CPC H04L 63/0869; H04L 63/0823; H04W 4/44; H04W 12/069

(57) ABSTRACT

An AVP (Automated Valet Parking) of a vehicle in a parking lot requires a wireless communication between the vehicle and a parking lot system. The parking lot system retains a first parking lot certificate necessary for mutual authentication between the vehicle and the parking lot system. A back-end system is capable of communicating with the vehicle. The vehicle acquires a second parking lot certificate from the back-end system via communication and retains it, the second parking lot certificate being associated with the first parking lot certificate and being necessary for verifying the first parking lot certificate. When performing the mutual authentication with the parking lot system for establishing the wireless communication, the vehicle receives the first parking lot certificate from the parking lot system and verifies the first parking lot certificate by using the second parking lot certificate.

### CROSS-REFERENCES TO RELATED APPLICATION

The present disclosure claims priority to Japanese Patent Application No. 2025-016130, filed on February 3, 2025, the contents of which application are incorporated herein by reference in their entirety.

### TECHNICAL FIELD

The present disclosure relates to automated valet parking (AVP: Automated Valet Parking) of a vehicle in a parking lot.

### BACKGROUND ART

Patent Literature 1 discloses automated valet parking in a parking lot. A vehicle that supports the automated valet parking acquires route information from a parking lot system and autonomously travels along the acquired route.

### List of Related Art

Patent Literature 1: German Patent Application Publication No. 102012222562

### SUMMARY

In automated valet parking, a wireless communication is performed between a vehicle and a parking lot system (infrastructure). When establishing the wireless communication, it is desirable to perform mutual authentication between the vehicle and the parking lot system. However, it is difficult to preinstall parking lot certificates for mutual authentication in the vehicle, with regard to all of many and unspecified number of parking lots. Even if parking lot certificates of existing parking lots are preinstalled in the vehicle, it is not possible to cope with a parking lot that is newly installed thereafter.

An object of the present disclosure is to provide a technique that enables mutual authentication between a vehicle and a parking lot system in any parking lot.

A first aspect is directed to a vehicle having an automated valet parking function.

A target parking lot is a parking lot used by the vehicle.

A parking lot system is configured to manage automated valet parking in the target parking lot.

The automated valet parking of the vehicle in the target parking lot requires a wireless communication between the vehicle and the parking lot system.

The parking lot system retains a first parking lot certificate that is a certificate of the parking lot system itself and is necessary for mutual authentication between the vehicle and the parking lot system.

A back-end system managing the vehicle is capable of communicating with the vehicle.

The vehicle includes one or more processors.

The one or more processors acquire a second parking lot certificate from the back-end system via communication, the second parking lot certificate being associated with the first parking lot certificate and being necessary for verifying the first parking lot certificate.

The one or more processors retain the second parking lot certificate acquired from the back-end system.

When performing the mutual authentication with the parking lot system for establishing the wireless communication, the one or more processors receive the first parking lot certificate from the parking lot system and verify the first parking lot certificate by using the second parking lot certificate.

A second aspect is directed to a back-end system capable of communicating with a vehicle having an automated valet parking function.

A target parking lot is a parking lot used by the vehicle.

A parking lot system is configured to manage automated valet parking in the target parking lot.

The automated valet parking of the vehicle in the target parking lot requires a wireless communication between the vehicle and the parking lot system.

The parking lot system retains a first parking lot certificate that is a certificate of the parking lot system itself and is necessary for mutual authentication between the vehicle and the parking lot system.

The back-end system includes one or more processors.

The one or more processors provide the vehicle with a second parking lot certificate via communication, the second parking lot certificate being associated with the first parking lot certificate and being necessary for verifying the first parking lot certificate.

When performing the mutual authentication between the vehicle and the parking lot system for establishing the wireless communication, the vehicle receives the first parking lot certificate from the parking lot system and verifies the first parking lot certificate by using the second parking lot certificate.

A third aspect is directed to an automated valet parking system.

The automated valet parking system includes:

a vehicle having an automated valet parking function; and

a back-end system that manages the vehicle and is capable of communicating with the vehicle.

A target parking lot is a parking lot used by the vehicle.

A parking lot system is configured to manage automated valet parking in the target parking lot.

The automated valet parking of the vehicle in the target parking lot requires a wireless communication between the vehicle and the parking lot system.

The parking lot system retains a first parking lot certificate that is a certificate of the parking lot system itself and is necessary for mutual authentication between the vehicle and the parking lot system.

The back-end system is configured to provide the vehicle with a second parking lot certificate via communication, the second parking lot certificate being associated with the first parking lot certificate and being necessary for verifying the first parking lot certificate.

The vehicle is configured to retain the second parking lot certificate acquired from the back-end system.

When performing the mutual authentication with the parking lot system for establishing the wireless communication, the vehicle is configured to receive the first parking lot certificate from the parking lot system and to verify the first parking lot certificate by using the second parking lot certificate.

According to the present disclosure, the parking lot certificate necessary for the mutual authentication between the vehicle and the parking lot system is provided from the back-end system to the vehicle. This makes it possible to achieve the mutual authentication between the vehicle and the parking lot system in any parking lot.

### BRIEF DESCRIPTION OF DRAWINGS

FIG. 1 is a conceptual diagram illustrating an overview of an automated valet parking system (AVP system);

FIG. 2 is a conceptual diagram for explaining an example of automated valet parking;

FIG. 3 is a conceptual diagram for explaining mutual authentication between a vehicle and a parking lot system;

FIG. 4 is a conceptual diagram for explaining a comparative example;

FIG. 5 is a conceptual diagram for explaining a method for providing a vehicle with a second parking lot certificate;

FIG. 6 is a conceptual diagram for explaining an example of a storage area for a certificate in a vehicle;

FIG. 7 is a conceptual diagram for explaining an example of interlocking with an AVP usage reservation;

FIG. 8 is a conceptual diagram for explaining an example of interlocking with activation (wake-up) of a vehicle in a parking lot;

FIG. 9 is a block diagram showing an example of a configuration of a vehicle;

FIG. 10 is a block diagram showing an example of a configuration of a of a back-end system;

FIG. 11 is a block diagram showing an example of a configuration of a parking

lot system;

FIG. 12 is a block diagram showing an example of a configuration of an AVP system;

FIG. 13 is a block diagram for explaining an example of processing in the AVP system;

FIG. 14 is a block diagram for explaining an example of processing in the AVP system;

FIG. 15 is a block diagram for explaining an example of processing in the AVP system;

FIG. 16 is a block diagram for explaining an example of processing in the AVP system;

FIG. 17 is a block diagram for explaining an example of processing in the AVP system; and

FIG. 18 is a block diagram for explaining an example of processing in the AVP system.

### DETAILED DESCRIPTION

Embodiments of the present disclosure will be described with reference to the accompanying drawings. In the following description, automated valet parking may be referred to as "AVP".

### 1. Automated Valet Parking System AVP system

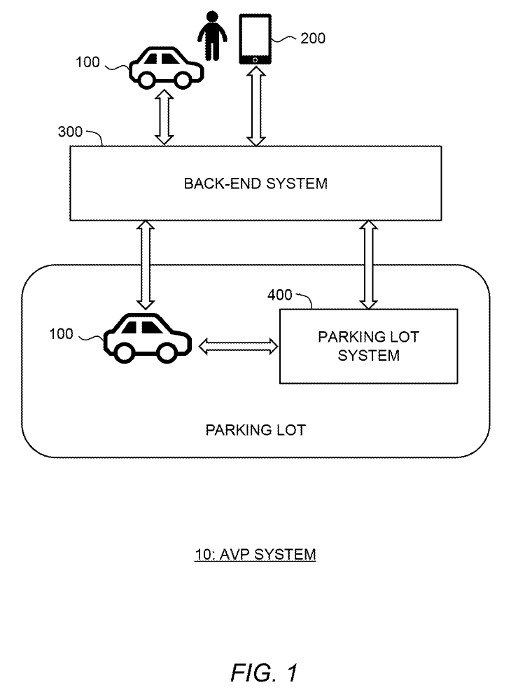

FIG. 1 is a conceptual diagram illustrating an overview of an AVP system 10 according to the present embodiment. The AVP system 10 is a system for the AVP in a parking lot. The AVP system 10 includes a vehicle 100, a user terminal 200, a back-end system 300, and a parking lot system 400.

The vehicle 100 is a target of the AVP in the parking lot. The vehicle 100 has a function of autonomously traveling at least in the parking lot.

The user terminal 200 is a terminal operated by a user of the AVP service, that is, a user of the vehicle 100. Examples of the user terminal 200 include a smartphone and a PC.

The back-end system 300 manages the AVP in one or more parking lots, users of the AVP service, the vehicles 100 being targets of the AVP, and the like. The parking lot system 400, which is an infrastructure system installed in a parking lot, manages the AVP in the parking lot. The back-end system 300 and the parking lot system 400 may be collectively referred to as a "management system." The management system manages the AVP in the parking lot.

The vehicle 100 and the back-end system 300 can communicate with each other. For example, the vehicle 100 and the back-end system 300 communicate with each other using a mobile communication service. In the parking lot, the vehicle 100 and the parking lot system 400 can perform a wireless communication with each other. For example, the vehicle 100 and the parking lot system 400 perform a wireless communication with each other using a wireless LAN. Moreover, the user terminal 200 and the back-end system 300 can communicate with each other. For example, the user terminal 200 and the back-end system 300 communicate with each other using a mobile communication service. Further, the back-end system 300 and the parking lot system 400 may communicate with each other in a wired or wireless manner.

An example of a flow of a reservation of the AVP service is as follows. It is assumed that member information of the users is registered in advance in the back-end system 300. First, a user makes a reservation of the AVP. For example, the user operates the user terminal 200 to input ID information of the user, a desired parking lot, a desired date of use, a desired time of use (i.e, a scheduled entry time and a scheduled exit time), and the like. The user terminal 200 transmits reservation request information including the input information to the back-end system 300. The back-end system 300 executes reservation processing based on the reservation request information, and sends a reservation completion notification to the user terminal 200. In addition, the back-end system 300 provides reservation information to the parking lot system 400 of the reserved parking lot.

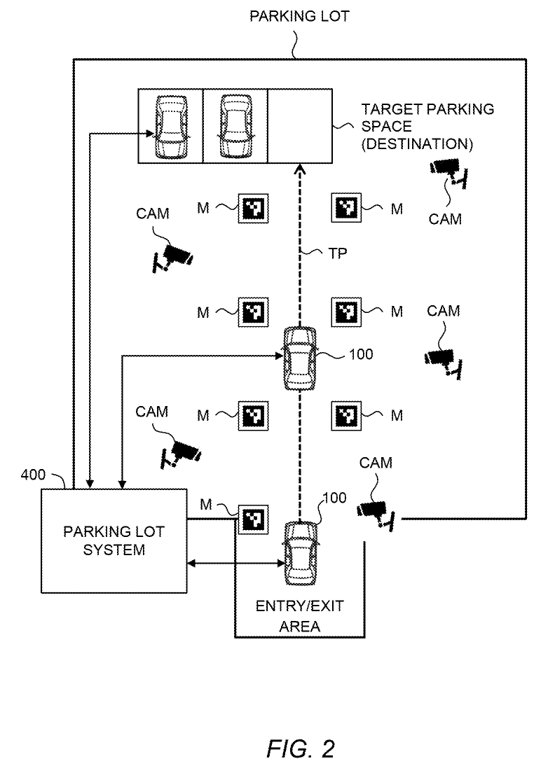

FIG. 2 is a conceptual diagram for explaining an example of the AVP in the parking lot.

The vehicle 100 recognizes a situation around the vehicle 100 by using a recognition sensor (for example, a camera) mounted on the vehicle 100. The vehicle 100 travels safely while recognizing the surrounding situation. A plurality of markers M (landmarks) may be arranged in the parking lot. The marker M is used for guiding the vehicle 100 in the parking lot. For example, the vehicle 100 acquires an image of the surroundings using the camera, and recognizes the marker M based on the image. Then, based on a result of recognition of the marker M, the vehicle 100 performs localization processing that estimates a position of the vehicle 100 in the parking lot with high accuracy. The vehicle 100 automatically travels in the parking lot based on the estimated vehicle position.

One or more infrastructure cameras CAM may be installed in the parking lot. The infrastructure camera CAM captures an image of the parking lot and acquires an image showing a situation of the parking lot. The parking lot system 400 communicates with the infrastructure camera CAM to acquire the image captured by the infrastructure camera CAM. The parking lot system 400 analyzes the image to detect the vehicle 100 shown in the image. Moreover, the parking lot system 400 estimates a position of the vehicle 100 shown in the image. Further, the parking lot system 400 manages the vehicle 100 in the parking lot based on the position of the vehicle 100. The parking lot system 400 may provide the vehicle 100 with the position information of the vehicle 100. The vehicle 100 may automatically travel in the parking lot based on the position information provided from the parking lot system 400.

An example of an entry process (check-in) is as follows. The vehicle 100 stops at an entry area. At the entry area, the user gets off the vehicle 100 and requests the entry by using the user terminal 200 or the like. The management system (i.e., at least one of the back-end system 300 and the parking lot system 400) conducts authentication of the user and the vehicle 100. Upon completion of the authentication, authority to operate the vehicle 100 is transferred from the user to the management system. The management system communicates with the vehicle 100 and activates the vehicle 100. Moreover, the parking lot system 400 allocates an available parking space to the vehicle 100. The allocated available parking space is a target parking space, that is, a destination for the vehicle 100 at the time of the entry. Further, the parking lot system 400 sets a travel path TP (a target trajectory) from the entry area to the target parking space in the parking lot. The parking lot system 400 sends an entry instruction to the vehicle 100. The entry instruction includes information on the target parking space and the travel path TP. In response to the entry instruction, the vehicle 100 automatically travels to the target parking space along the travel path TP. That is, the vehicle 100 automatically travels so as to follow the travel path TP based on the vehicle position. Then, the vehicle 100 is automatically parked in the target parking space. Upon completion of the parking, the management system instructs the vehicle 100 to stop the operation.

An example of an exit process (check-out) is as follows. The user requests the exit by using the user terminal 200 or the like. The management system communicates with the vehicle 100 and activates the vehicle 100. At the time of exit, a designated exit area is a destination for the vehicle 100. The parking lot system 400 sets a travel path TP (a target trajectory) from the parking space to the exit area in the parking lot. The parking lot system 400 sends an exit instruction to the vehicle 100. The exit instruction includes information on the designated exit area and the travel path TP. In response to the exit instruction, the vehicle 100 automatically travels to the exit area along the travel path TP. That is, the vehicle 100 automatically travels so as to follow the travel path TP based on the vehicle position. Then, the vehicle 100 automatically stops the vehicle 100 in the exit area. The authority to operate the vehicle 100 is transferred from the management system to the user. The user gets on the vehicle 100. The vehicle 100 starts moving to a next destination.

### 2. Mutual Authentication Between Vehicle and Parking Lot System

### 2-1. Overview

In the automated valet parking, a wireless communication is performed between the vehicle 100 and the parking lot system 400. When establishing the wireless communication, it is desirable to perform mutual authentication between the vehicle 100 and the parking lot system 400.

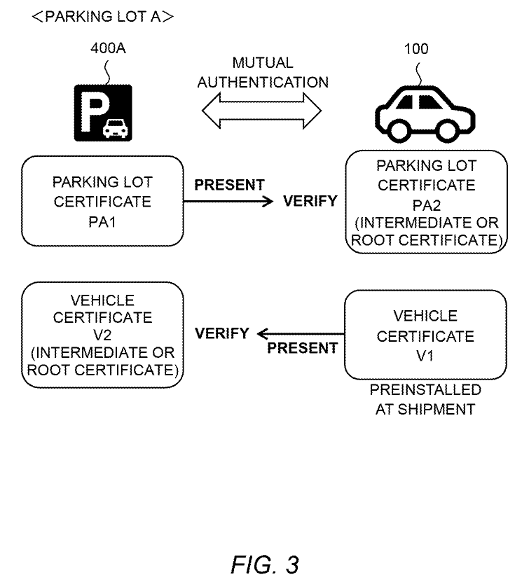

FIG. 3 is a conceptual diagram for explaining the mutual authentication between the vehicle 100 and the parking lot system 400. In the example shown in FIG. 3, a target parking lot used by the vehicle 100 is a parking lot A. A parking lot system 400A is installed in the parking lot A and manages the AVP in the parking lot A. The AVP of the vehicle 100 in the parking lot A is achieved by performing a wireless communication between the vehicle 100 and the parking lot system 400A. In order to establish the wireless communication, the mutual authentication is performed between the vehicle 100 and the parking lot system 400A. The following various certificates are required for the mutual authentication between the vehicle 100 and the parking lot system 400A.

The vehicle 100 retains a "vehicle certificate V1 (first vehicle certificate)" that is a certificate of the vehicle 100 itself. The vehicle certificate V1 corresponds to a client certificate that proves identity of the vehicle 100. On the other hand, the parking lot system 400A retains a "parking lot certificate PA1 (first parking lot certificate)" that is a certificate of the parking lot system 400A itself. The parking lot certificate PA1 corresponds to a server certificate that proves identity the parking lot system 400A.

In addition, the vehicle 100 retains a "parking lot certificate PA2 (second parking lot certificate)" necessary for verifying the parking lot certificate PA1 presented from the parking lot system 400A. The parking lot certificate PA2 is an intermediate certificate or a root certificate, and is associated with the parking lot certificate PA1. For example, the parking lot certificate PA2 is an intermediate certificate associated with the parking lot certificate PA1. On the other hand, the parking lot system 400A retains a "vehicle certificate V2 (second vehicle certificate)" necessary for verifying the vehicle certificate V1 presented from vehicle 100. The vehicle certificate V2 is an intermediate certificate or a root certificate, and is associated with the vehicle certificate V1. For example, the vehicle certificate V2 is an intermediate certificate associated with the vehicle certificate V1.

The mutual authentication between the vehicle 100 and the parking lot system 400A is as follows. The vehicle 100 presents the vehicle certificate V1 (the first vehicle certificate) to the parking lot system 400A. The parking lot system 400A receives the vehicle certificate V1 from the vehicle 100, and verifies the vehicle certificate V1 by using the vehicle certificate V2 (the second vehicle certificate). On the other hand, the parking lot system 400A presents the parking lot certificate PA1 (the first parking lot certificate) to the vehicle 100. The vehicle 100 receives the parking lot certificate PA1 (the first parking lot certificate) from the parking lot system 400A, and verifies the parking lot certificate PA1 (the first parking lot certificate) by using the parking lot certificate PA2 (the second parking lot certificate). In this manner, the mutual authentication between the vehicle 100 and the parking lot system 400A is achieved, and the wireless communication between the vehicle 100 and the parking lot system 400A is established.

As described above, in order to achieve the mutual authentication between the vehicle 100 and the parking lot system 400A, the vehicle 100 is required to retain the parking lot certificate PA2 regarding the parking lot system 400A together with the vehicle certificate V1 of the vehicle 100 itself. The vehicle certificate V1 is preinstalled in the vehicle 100 at the time of shipment, for example. Meanwhile, there is room for consideration as to how the vehicle 100 acquires the parking lot certificate PA2.

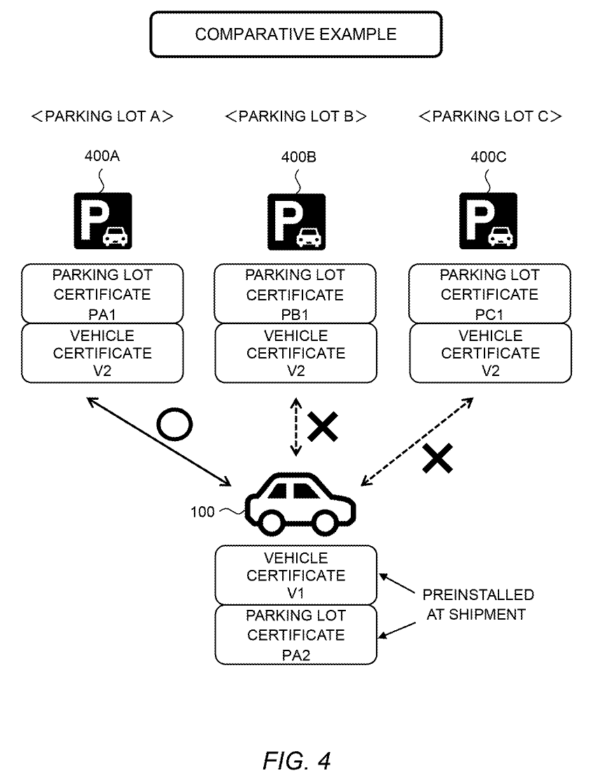

FIG. 4 is a conceptual diagram for explaining a comparative example. A parking lot system 400A of a parking lot A retains a parking lot certificate PA1 (first parking lot certificate) that is a certificate of the parking lot system 400A itself. A parking lot system 400B of a parking lot B retains a parking lot certificate PB1 (first parking lot certificate) that is a certificate of the parking lot system 400B itself. A parking lot system 400C of a parking lot C retains a parking lot certificate PC1 (first parking lot certificate) that is a certificate of the parking lot system 400C itself. In the comparative example, a parking lot certificate PA2 (second parking lot certificate) regarding the parking lot system 400A is preinstalled in the vehicle 100 at the time of shipment of the vehicle 100. In this case, the mutual authentication between the vehicle 100 and the parking lot system 400A is possible. However, mutual authentication between the vehicle 100 and the parking lot system 400B of the parking lot B is not possible. Likewise, mutual authentication between the vehicle 100 and the parking lot system 400C of parking lot C is not possible.

In order to achieve the mutual authentication between the vehicle 100 and the parking lot system 400B, the vehicle 100 needs to retain a parking lot certificate PB2 (second parking lot certificate) associated with the parking lot certificate PB1. In order to achieve the mutual authentication between the vehicle 100 and the parking lot system 400C, the vehicle 100 needs to retain a parking lot certificate PC2 (second parking lot certificate) associated with the parking lot certificate PC1. However, it is difficult to preinstall the second parking lot certificates in the vehicle 100 with regard to all of many and unspecified number of parking lots. Even if the second parking lot certificates of existing parking lots are preinstalled in the vehicle 100, it is not possible to cope with a new parking lot that is newly installed thereafter.

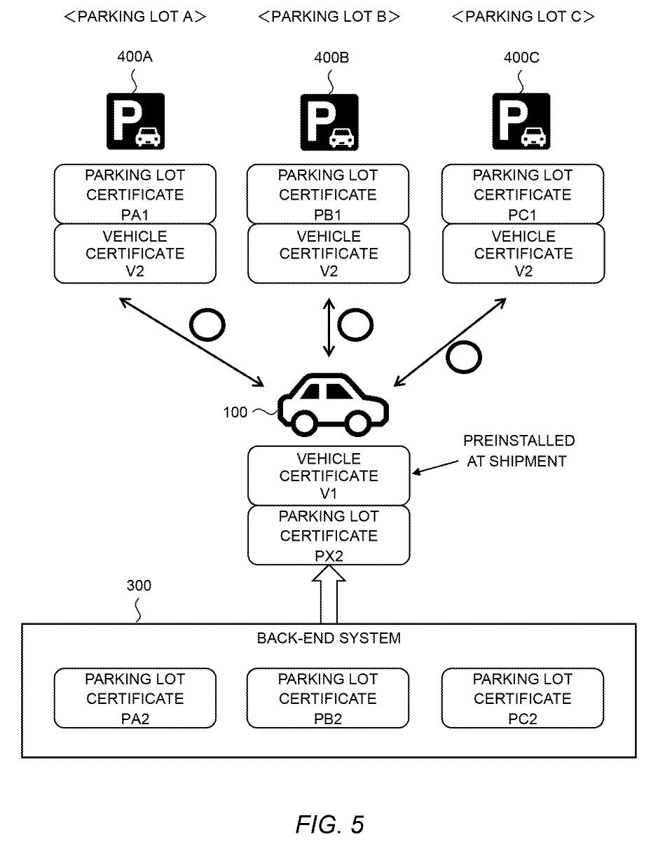

FIG. 5 is a conceptual diagram for explaining a method for providing (distributing) the second parking lot certificate to the vehicle according to the present embodiment. In the present embodiment, the back-end system 300 managing the vehicle 100 is used. The vehicle 100 and the back-end system 300 are capable of communicating with each other. By the way, any certificate (an intermediate certificate, a root certificate) necessary for mutual authentication between the vehicle 100 and the back-end system 300 is preinstalled in the vehicle 100 at the time of shipment, for example. Although there are various target parking lots used by the vehicle 100, the back-end system 300 is uniquely determined. Therefore, no particular problem occurs when the certificate regarding the back-end system 300 is preinstalled in the vehicle 100.

The back-end system 300 can acquire a parking lot certificate PX2 (second parking lot certificate) regarding a parking lot system 400X of any parking lot X (for example, X = A, B, C). The parking lot certificate PX2 (the second parking lot certificate), which is associated with a parking lot certificate PX1 (first parking lot certificate) retained by the parking lot system 400X, is provided from the parking lot system 400X. The back-end system 300 acquires the parking lot certificate PX2 from the parking lot system 400X through communication. Further, the back-end system 300 provides (distributes) the parking lot certificate PX2 to the vehicle 100 via communication.

The vehicle 100 acquires the parking lot certificate PX2 from the back-end system 300 via communication. The vehicle 100 retains the parking lot certificate PX2 acquired from the back-end system 300. In order to establish a wireless communication between the vehicle 100 and the parking lot system 400X of the target parking lot X, the mutual authentication is performed between the vehicle 100 and the parking lot system 400X. In the mutual authentication, the vehicle 100 receives the parking lot certificate PX1 (the first parking lot certificate) from the parking lot system 400X. Then, the vehicle 100 verifies the parking lot certificate PX1 (the first parking lot certificate) by using the parking lot certificate PX2 (the second parking lot certificate) retained therein. In this manner, the mutual authentication between the vehicle 100 and the parking lot system 400X is achieved, and the wireless communication between the vehicle 100 and the parking lot system 400X is established.

According to the present embodiment, it is not necessary to preinstall the parking lot certificate PX2 regarding the target parking lot X in the vehicle 100. The parking lot certificate PX2 may not be preinstalled in the vehicle 100. Instead, the parking lot certificate PX2 necessary for the mutual authentication between the vehicle 100 and the parking lot system 400X of the target parking lot X is provided from the back-end system 300 to the vehicle 100. This makes it possible to achieve the mutual authentication between the vehicle 100 and the parking lot system 400X in any parking lot X. Moreover, it is possible to cope with a new parking lot X that is newly installed after the shipment of the vehicle 100.

### 2-2. Certificate Storage Area in Vehicle

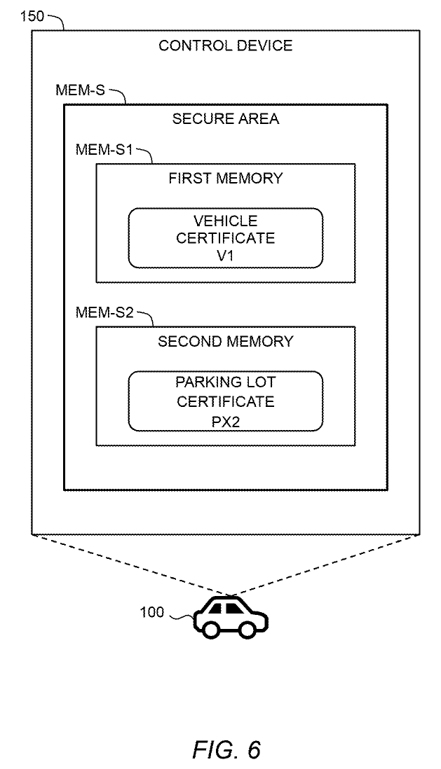

FIG. 6 is a conceptual diagram for explaining an example of a storage area for the certificates in the vehicle 100. The vehicle 100 is provided with a control device 150 that controls the vehicle 100. The control device 150 includes a secure area MEM-S that is a memory area with high security. The vehicle certificate V1 (the first vehicle certificate) and the parking lot certificate PX2 (the second parking lot certificate) are stored in the secure area MEM-S.

The vehicle certificate V1 (the first vehicle certificate) and the parking lot certificate PX2 (the second parking lot certificate) may be stored in different places. For example, the secure area MEM-S includes a first memory MEM-S1 and a second memory MEM-S2. The vehicle certificate V1 (the first vehicle certificate) is stored in the first memory MEM-S1. The parking lot certificate PX2 (the second parking lot certificate) is stored in the second memory MEM-S2.

The vehicle certificate V1 (the first vehicle certificate) is used for a long time. Therefore, the vehicle certificate V1 (the first vehicle certificate) may be stored in a memory area with a particularly high security level. Meanwhile, an update frequency of the parking lot certificate PX2 (the second parking lot certificate) is assumed to be higher than an update frequency of the vehicle certificate V1 (the first vehicle certificate). Therefore, the parking lot certificate PX2 (the second parking lot certificate) may be stored in a memory area that is relatively easy to access. From the above viewpoint, the security level of the first memory MEM-S1 may be higher than the security level of the second memory MEM-S2. Conversely, the security level of the second memory MEM-S2 may be lower than the security level of the first memory MEM-S1.

### 2-3. Example of Interlocking with AVP Use Reservation

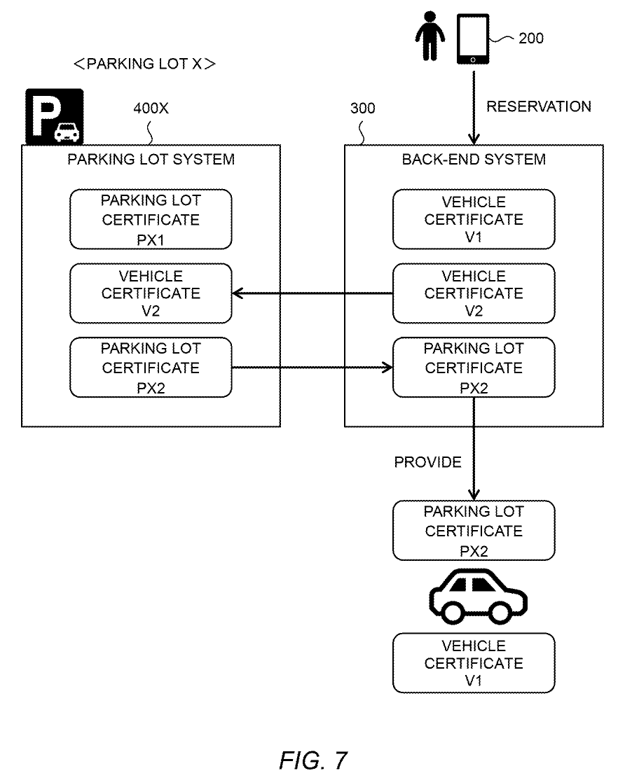

FIG. 7 is a conceptual diagram for explaining an example of interlocking with an AVP use reservation. In the example shown in FIG. 7, the back-end system 300 provides the vehicle 100 with the parking lot certificate PX2 in conjunction with a reservation of the AVP in the target parking lot X. The vehicle 100 acquires the parking lot certificate PX2 from the back-end system 300 in conjunction with the reservation of the AVP in the target parking lot X.

More specifically, the user of the vehicle 100 operates the user terminal 200 to make a reservation of use of the AVP in the target parking lot X. The back-end system 300 receives an AVP use reservation of the vehicle 100 in the target parking lot X. The back-end system 300 managing the vehicle 100 retains the vehicle certificate V1 (the first vehicle certificate) and the vehicle certificate V2 (the second vehicle certificate) regarding the vehicle 100. In response to the AVP use reservation, the back-end system 300 provides the parking lot system 400X of the target parking lot X with the vehicle certificate V2 (the second vehicle certificate) regarding the vehicle 100 (the target vehicle) via communication.

The parking lot system 400X of the target parking lot X receives the vehicle certificate V2 (the second vehicle certificate) regarding the vehicle 100 (the target vehicle) from the back-end system 300 via communication. The parking lot system 400X retains the received vehicle certificate V2. The retained vehicle certificate V2 (the second vehicle certificate) is used for the mutual authentication (see FIGS. 3 and 5). In addition, the parking lot system 400X creates the parking lot certificate PX2 (the second parking lot certificate). The parking lot system 400X provides the back-end system 300 with the parking lot certificate PX2 (the second parking lot certificate) via communication.

The back-end system 300 receives the parking lot certificate PX2 (the second parking lot certificate) from the parking lot system 400X via communication. The back-end system 300 provides the vehicle 100 (the target vehicle) with the parking lot certificate PX2 (the second parking lot certificate) regarding the parking lot system 400X via communication.

The vehicle 100 receives the parking lot certificate PX2 (the second parking lot certificate) regarding the parking lot system 400X from the back-end system 300 via communication. The vehicle 100 retains the received parking lot certificate PX2 (the second parking lot certificate). For example, the parking lot certificate PX2 (the second parking lot certificate) is stored in the second memory MEM-S2 in the vehicle 100 (see FIG. 6). The retained parking lot certificate PX2 (the second parking lot certificate) is used for the mutual authentication (see FIGS. 3 and 5).

### 2-4. Example of Interlocking with Activation Wake-up of Vehicle

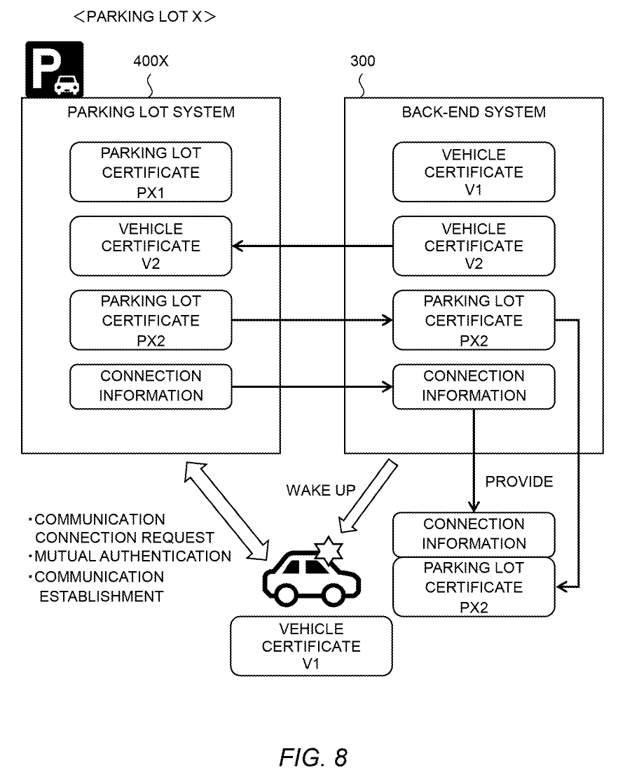

FIG. 8 is a conceptual diagram for explaining an example of interlocking with activation (wake-up) of the vehicle 100 in the target parking lot X. In the example shown in FIG. 8, the back-end system 300 provides the vehicle 100 with the parking lot certificate PX2 in conjunction with the activation of the vehicle 100 in the target parking lot X. The vehicle 100 acquires the parking lot certificate PX2 from the back-end system 300 in conjunction with the activation in the target parking lot X.

More specifically, after the vehicle 100 arrives at the target parking lot X, the user gets off the vehicle 100 and requests the AVP start. The back-end system 300 transmits a wake-up request to the vehicle 100 (the target vehicle) via communication. In response to the wake-up request, the AVP function of the vehicle 100 is activated. Furthermore, the back-end system 300 provides the vehicle 100 with connection information and the parking lot certificate PX2 (the second parking lot certificate) regarding the parking lot system 400X via communication. The connection information includes an SSID and the like of the parking lot system 400X.

The vehicle 100 receives the connection information and the parking lot certificate PX2 (the second parking lot certificate) regarding the parking lot system 400X from the back-end system 300 via communication. The vehicle 100 retains the received connection information and the received parking lot certificate PX2 (the second parking lot certificate). For example, the parking lot certificate PX2 (the second parking lot certificate) is stored in the second memory MEM-S2 in the vehicle 100 (see FIG. 6).

The vehicle 100 requests the parking lot system 400X of the target parking lot X for communication connection based on the connection information (SSID). The vehicle 100 and the parking lot system 400X perform the mutual authentication by using the certificates (see FIGS. 3 and 5). Then, the wireless communication between the vehicle 100 and the parking lot system 400X is established.

It should be noted that a timing at which the back-end system 300 acquires the connection information and the parking lot certificate PX2 (the second parking lot certificate) from the parking lot system 400X is arbitrary and not limited in particular. For example, as illustrated in FIG. 7, the back-end system 300 may acquire the parking lot certificate PX2 (the second parking lot certificate) from the parking lot system 400X at the time of the AVP reservation. As another example, the back-end system 300 may acquire the parking lot certificate PX2 (the second parking lot certificate) from the parking lot system 400X in conjunction with the wake-up of the vehicle 100. In addition, the back-end system 300 may acquire the connection information from the parking lot system 400X in conjunction with the wake-up of the vehicle 100.

### 2-5. Period for Retaining Second Parking Lot Certificate

Various examples are conceivable as a period during which the vehicle 100 retains the parking lot certificate PX2 (the second parking lot certificate).

In a first example, the vehicle 100 deletes the parking lot certificate PX2 (the second parking lot certificate) after the vehicle 100 finishes using the target parking lot X.

In a second example, the vehicle 100 continues to retain the parking lot certificate PX2 (the second parking lot certificate) until its expiration date. In this example, the vehicle 100 may skip the process of newly acquiring the parking lot certificate PX2 until the expiration date of the already-retained parking lot certificate PX2.

In a third example, the vehicle 100 changes the period for retaining the parking lot certificate PX2 (the second parking lot certificate) according to a frequency of use of the target parking lot X. For example, the user may frequently use a specific target parking lot X. Examples of the specific target parking lot X with a high use frequency include a parking lot of a home apartment of the user. As another example, when the user is a rental car company, a frequency of use of a rental car parking lot is high. As the frequency of use of the target parking lot X becomes higher, the period for retaining the parking lot certificate PX2 (the second parking lot certificate) is set to be longer. The vehicle 100 may skip the process of newly acquiring the parking lot certificate PX2 until the retaining period of the already-retained parking lot certificate PX2 ends.

### 3. Configuration Example of Vehicle

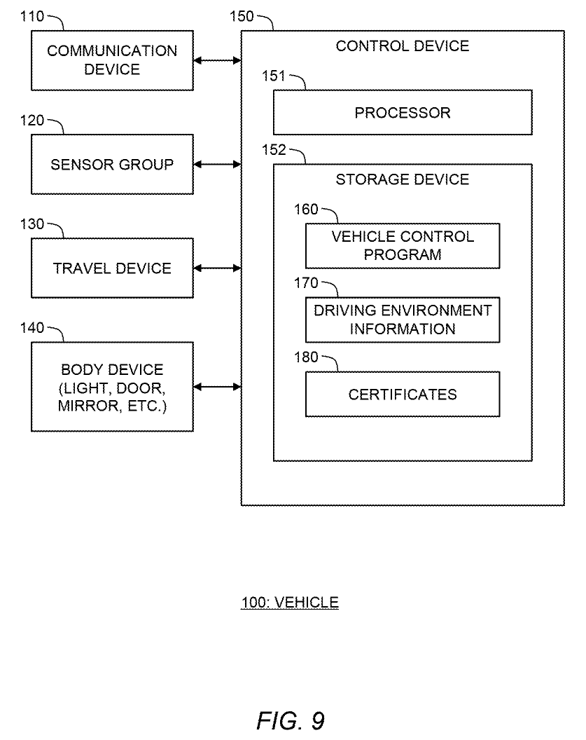

FIG. 9 is a block diagram showing a configuration example of the vehicle 100 according to the present embodiment. The vehicle 100 includes a communication device 110, a sensor group 120, a travel device 130, a body device 140, and a control device 150.

The communication device 110 includes an antenna and a transmission/reception circuit.

The sensor group 120 includes a recognition sensor, a vehicle state sensor, and the like. The recognition sensor is used for recognizing (detecting) a situation around the vehicle 100. Examples of the recognition sensor include a camera, a laser imaging detection and ranging (LIDAR), a radar, and the like. The vehicle state sensor includes a speed sensor, an acceleration sensor, a yaw rate sensor, a steering angle sensor, and the like.

The travel device 130 includes a steering device, a driving device, and a braking device. The steering device turns wheels. For example, the steering device includes an electric power steering (EPS) device. The driving device is a power source that generates a driving force. Examples of the driving device include an engine, an electric motor, an in-wheel motor, and the like. The braking device generates a braking force.

The body device 140 includes a light, a door, a door mirror, and the like. Examples of the light include a blinker (direction indicator), a headlight, a brake light, a fog light, and the like.

The control device 150 is a computer that controls the vehicle 100. The control device 150 includes one or more processors 151 (hereinafter, simply referred to as a processor 151) and one or more storage devices 152 (hereinafter, simply referred to as a storage device 152). The processor 151 executes a variety of processing. Examples of the processor 151 include a general-purpose processor, a special-purpose processor, a central processing unit (CPU), a graphics processing unit (GPU), an application specific integrated circuit (ASIC), a field-programmable gate array (FPGA), an integrated circuit, and / or a combination thereof. The processor 151 may also be referred to as processing circuitry. The storage device 152 stores a variety of information. Examples of the storage device 152 include a volatile memory, a nonvolatile memory, a hard disk drive (HDD), a solid state drive (SSD), and the like.

A vehicle control program 160 is a computer program for controlling the vehicle 100. The functions of the control device 150 may be realized by a cooperation between the processor 151 executing the vehicle control program 160 and the storage device 152. The vehicle control program 160 is stored in the storage device 152. Alternatively, the vehicle control program 160 may be recorded on a non-transitory computer-readable recording medium.

The control device 150 communicates with the back-end system 300 and the parking lot system 400 via the communication device 110.

The control device 150 executes vehicle travel control for controlling travel of the vehicle 100. The vehicle travel control includes steering control, acceleration control, and deceleration control. The control device 150 executes the vehicle travel control by controlling the travel device 130 (i.e., the steering device, the driving device, and the braking device).

In addition, the control device 150 controls the body device 140. For example, the control device 150 is configured to ON/OFF control the light.

Moreover, the control device 150 acquires driving environment information 170 indicating a driving environment for the vehicle 100. The driving environment information 170 is stored in the storage device 152. For example, the driving environment information 170 includes surrounding situation information, vehicle state information, map information, position information, and the like.

The surrounding situation information indicates the result of recognition by the recognition sensor. The surrounding situation information may include object information regarding an object recognized by the recognition sensor. Examples of the object around the vehicle 100 include an obstacle, a white line, a marker M, and the like. Examples of the obstacle include a wall, a pillar, another vehicle, and the like. The object information indicates a relative position and a relative speed of the object with respect to the vehicle 100.

The vehicle state information indicates the vehicle state detected by the vehicle state sensor. Examples of the vehicle state include a speed, an acceleration, a yaw rate, a steering angle, and the like.

The map information is map information of the parking lot in which the vehicle 100 travels. The map information indicates an arrangement of roads in the parking lot. In addition, the map information indicates an arrangement of stationary obstacles (for example, walls and pillars) in the parking lot. The map information further indicates an arrangement of the markers M in the parking lot. For example, the map information is provided from the parking lot system 400 that manages the parking lot. The control device 150 acquires the map information from the parking lot system 400.

The position information indicates a current position of the vehicle 100 in the parking lot. For example, the control device 150 acquires the position information with high accuracy by performing localization processing (localization). More specifically, the control device 150 calculates a rough position of the vehicle 100 in the parking lot based on the vehicle state information (specifically, the steering angle and the speed). Moreover, the control device 150 recognizes the marker M around the vehicle 100 by using the recognition sensor. In addition, the control device 150 acquires the arrangement information of the markers M around the vehicle 100 from the map information. The control device 150 corrects the position of the vehicle 100 by matching the recognition result of the marker M with the arrangement of the markers M. Accordingly, the position information with high accuracy is obtained.

Alternatively, the position information of the vehicle 100 may be estimated by the parking lot system 400 based on the image captured by the infrastructure camera CAM. In this case, the control device 150 may acquire the position information from the parking lot system 400.

Further, the control device 150 acquires information on the travel path TP in the parking lot. For example, the travel path TP is determined by the parking lot system 400, and the control device 150 acquires information on the travel path TP from the parking lot system 400. As another example, the control device 150 may determine the travel path TP based on the map information and the position information. Then, the control device 150 executes the vehicle travel control based on the position information such that the vehicle 100 travels along the travel path TP.

The storage device 152 is further configured to store certificates 180 necessary for the mutual authentication. The certificates 180 include the vehicle certificate V1 (the first vehicle certificate) and the parking lot certificate PX2 (the second parking lot certificate). For example, the storage device 152 includes the first memory MEM-S1 and the second memory MEM-S2 that are secure (see FIG. 6). The first memory MEM-S1 stores the first vehicle certificate V1. The second memory MEM-S2 stores the parking lot certificate PX2 (the second parking lot certificate). The security level of the first memory MEM-S1 may be higher than the security level of the second memory MEM-S2.

The vehicle certificate V1 (the first vehicle certificate) is stored (preinstalled) in the storage device 152, for example, at the time of shipment of the vehicle 100. In addition, the control device 150 receives the parking lot certificate PX2 (the second parking lot certificate) from the back-end system 300 via the communication device 110, and stores the received parking lot certificate PX2 (the second parking lot certificate) in the storage device 152.

At the time of the mutual authentication with the parking lot system 400X of the target parking lot X, the control device 150 transmits the vehicle certificate V1 (the first vehicle certificate) to the parking lot system 400X via the communication device 110. Moreover, the control device 150 receives the parking lot certificate PX1 (the first parking lot certificate) from the parking lot system 400X via the communication device 110. The control device 150 verifies the parking lot certificate PX1 (the first parking lot certificate) by using the parking lot certificate PX2 (the second parking lot certificate).

### 4. Configuration Example of Back End-System

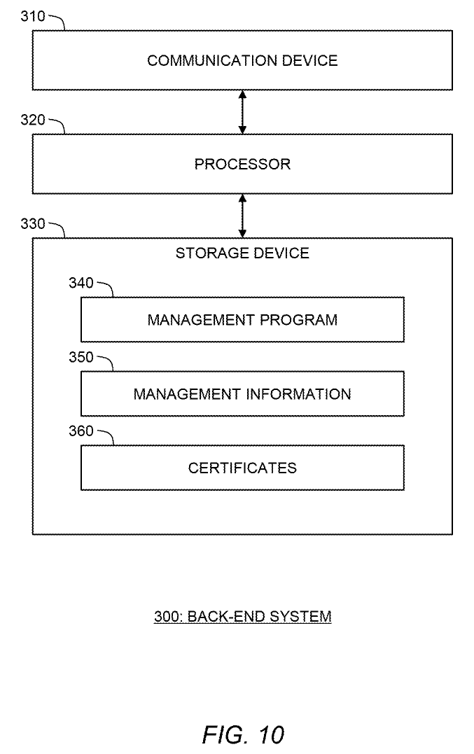

FIG. 10 is a block diagram showing a configuration example of the back-end system 300 according to the present embodiment. The back-end system 300 includes a communication device 310, one or more processors 320 (hereinafter simply referred to as a processor 320), and one or more storage devices 330 (hereinafter simply referred to as a storage device 330).

The communication device 310 communicates with each vehicle 100. In addition, the communication device 310 communicates with the user terminal 200 of each user. Further, the communication device 310 communicates with the parking lot system 400 of each parking lot.

The processor 320 executes a variety of processing. Examples of the processor 320 include a general purpose processor, a special purpose processor, a CPU, a GPU, an ASIC, an FPGA, an integrated circuit, and / or combinations thereof. The processor 320 may also be referred to as processing circuitry. The storage device 330 stores a variety of information. Examples of the storage device 330 include a volatile memory, a nonvolatile memory, an HDD, an SSD, and the like.

A management program 340 is a computer program for managing the AVP in the parking lot. The functions of the back-end system 300 may be realized by a cooperation between the processor 320 executing the management program 340 and the storage device 330. The management program 340 is stored in the storage device 330. The management program 340 may be recorded on a non-transitory computer-readable recording medium.

The processor 320 communicates with the vehicle 100, the user terminal 200, and the parking lot system 400 via the communication device 310.

The storage device 330 stores management information 350. The management information 350 may include the user information and the reservation information regarding each user. The management information 350 may include facility information and reservation status information regarding each parking lot. When the processor 320 receives the reservation request information from the user, the processor 102 may perform a reservation process based on the management information 350.

The storage device 330 is further configured to store certificates 360. For example, the certificates 360 include the vehicle certificate V1 (the first vehicle certificate), the vehicle certificate V2 (the second vehicle certificate), and the parking lot certificate PX2 (the second parking lot certificate). The processor 320 transmits the vehicle certificate V2 (the second vehicle certificate) to the parking lot system 400X via the communication device 310. Moreover, the processor 320 receives the parking lot certificate PX2 (the second parking lot certificate) from the parking lot system 400X via the communication device 310. Furthermore, the processor 320 transmits the parking lot certificate PX2 (the second parking lot certificate) to the vehicle 100 via the communication device 310.

### 5. Configuration Example of Parking Lot System

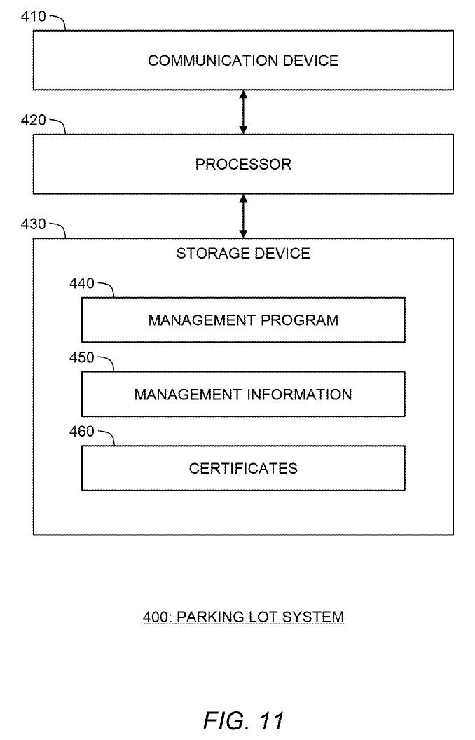

FIG. 11 is a block diagram showing a configuration example of the parking lot system 400 according to the present embodiment. The parking lot system 400 includes a communication device 410, one or more processors 420 (hereinafter simply referred to as a processor 420), and one or more storage devices 430 (hereinafter simply referred to as a storage device 430).

The communication device 410 communicates with each vehicle 100. In addition, the communication device 410 communicates with the back-end system 300. Further, the communication device 410 may communicate with the infrastructure camera CAM installed in the parking lot.

The processor 420 executes a variety of processing. Examples of the processor 420 include a general purpose processor, a special purpose processor, a CPU, a GPU, an ASIC, an FPGA, an integrated circuit, and / or combinations thereof. The processor 420 may also be referred to as processing circuitry. The storage device 430 stores a variety of information. Examples of the storage device 430 include a volatile memory, a nonvolatile memory, an HDD, an SSD, and the like.

A management program 440 is a computer program for managing the parking lot. The functions of the parking lot system 400 may be realized by a cooperation between the processor 420 executing the management program 440 and the storage device 430. The management program 440 is stored in the storage device 430. The management program 440 may be recorded on a non-transitory computer-readable recording medium.

The processor 420 communicates with the vehicle 100 and the back-end system 300 via the communication device 410. The processor 420 may also communicate with the user terminal 200 via the communication device 410 and the back-end system 300.

The storage device 430 stores management information 450 for managing the parking lot. The management information 450 includes the map information of the parking lot. The processor 420 may provide the map information to the vehicle 100 via the communication device 410. Moreover, the management information 450 indicates a usage status (vacancy status) of the parking spaces in the parking lot. The processor 420 can allocate an available parking space (destination) to the vehicle 100 based on the management information 450.

The management information 450 may further include vehicle management information. The vehicle management information includes the position information of each vehicle 100 in the parking lot. The processor 420 may communicate with each vehicle 100 via the communication device 410 and collect the position information from each vehicle 100. Alternatively, the processor 420 may acquire the image captured by the infrastructure camera CAM installed in the parking lot and estimate the position of each vehicle 100 based on the image. The vehicle management information may include the travel path TP allocated to each vehicle 100. The processor 420 can determine the travel path TP allocated to each vehicle 100 based on the position information 174 the vehicle 100, the destination, and the map information. The processor 420 may provide the information on the travel path TP to the vehicle 100 via the communication device 410.

The storage device 430 is further configured to store certificates 460. For example, the certificate 460 includes the parking lot certificate PX1 (the first parking lot certificate), the parking lot certificate PX2 (the second parking lot certificate), and the vehicle certificate V2 (the second vehicle certificate). The processor 420 receives the vehicle certificate V2 (the second vehicle certificate) from the back-end system 300 via the communication device 410. Moreover, the processor 420 transmits the parking lot certificate PX2 (the second parking lot certificate) to the back-end system 300 via the communication device 410.

At the time of the mutual authentication with the vehicle 100, the processor 420 transmits the parking lot certificate PX1 (the first parking lot certificate) to the vehicle 100 via the communication device 410. Moreover, the processor 420 receives the vehicle certificate V1 (the first vehicle certificate) from the vehicle 100 via the communication device 410. The processor 420 verifies the vehicle certificate V1 (the first vehicle certificate) by using the vehicle certificate V2 (the second vehicle certificate).

### 6. Example of Processing in AVP System

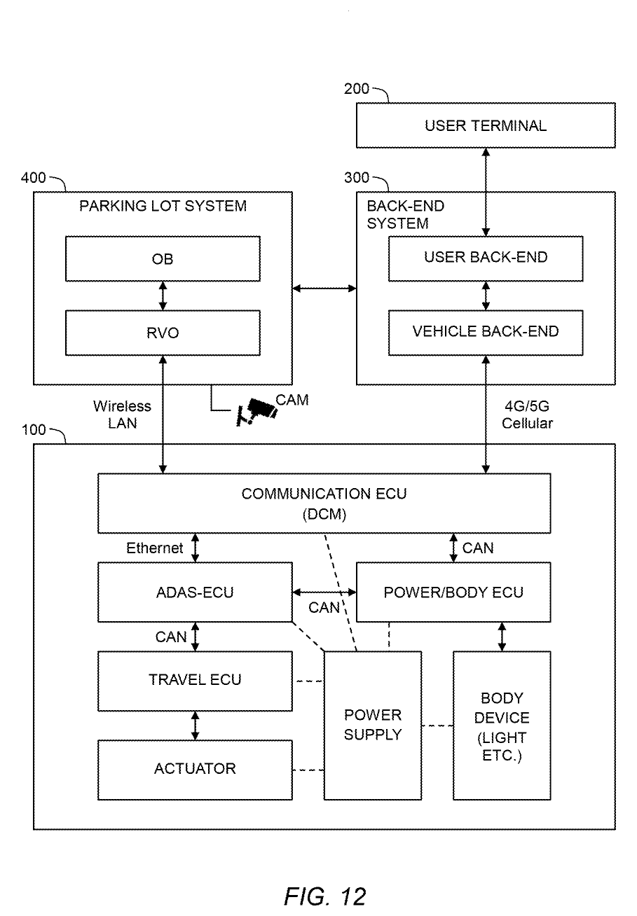

FIG. 12 is a block diagram showing an example of a configuration of the AVP system 10. The AVP system 10 includes the vehicle 100, the user terminal 200, the back-end system 300, and the parking lot system 400.

The vehicle 100 has a power supply, an actuator (corresponding to the travel device 130 in FIG. 9), a body device (for example, a light, a door, and a mirror), and the like. The vehicle 100 further has a communication ECU (Electronic Control Unit), an ADAS-ECU, a travel ECU, and a power/body ECU. These ECUs are included in the control device 150 described above (see FIG. 9).

The communication ECU controls the communication with the back-end system 300 and the parking lot system 400 (e.g., cellular communication control, wireless LAN communication control). The communication ECU is also referred to as a data communication module (DCM). The communication ECU may retain the certificates for the mutual authentication. The communication ECU may include the secure area MEM-S illustrated in FIG. 6. The communication ECU may include the first memory MEM-S1 and the second memory MEM-S2 illustrated in FIG. 6. The first memory MEM-S1 stores the first vehicle certificate V1. The second memory MEM-S2 stores the second parking lot certificate PX2.

The ADAS-ECU controls automated driving in the AVP. The ADAS-ECU manages the state of the vehicle 100 during the AVP. The ADAS-ECU has a planner function. The ADAS-ECU calculates a control amount.

The travel ECU controls travel of the vehicle 100. More specifically, the travel ECU controls an operation of the actuator in accordance with the control amount calculated by the ADAS-ECU. The travel ECU includes a motion manager.

The power/body ECU performs power supply control and manages a power supply state. Moreover, the power/body ECU controls the body devices such as a light, a door, a mirror, and the like, and manages states of the body devices.

The communication ECU and the ADAS-ECU are connected to each other via, for example, Ethernet (registered trademark). The other ECUs are connected to each other via, for example, a controller area network (CAN).

The back-end system 300 includes a user back-end and a vehicle back-end. The user back-end and the vehicle back-end are able to communicate with each other and to share information.

The user back-end communicates with the user terminal 200. The user back-end performs user authentication. In addition, the user back-end has an AVP reservation DB and manages reservations of the AVP.

The vehicle back-end communicates with the vehicle 100. For example, the vehicle back-end communicates with the vehicle 100 via a cellular network. The vehicle back-end may check consistency in a communication interface between the vehicle 100 and the vehicle back-end. The vehicle back-end may issue the vehicle certificate. The vehicle back-end may manage power control authority of the vehicle 100. The vehicle back-end may store AVP vehicle information and AVP driving log that are transmitted from the vehicle 100.

The parking lot system 400 includes a remote vehicle operation (RVO) installed in the parking lot. The RVO performs vehicle recognition, localization, obstacle recognition, and the like by the use of infrastructure cameras installed in the parking lot. The RVO may include a planner function. The RVO communicates with the vehicle 100 via the wireless LAN.

The parking lot system 400 may further include a cloud system (OB). The RVO and the cloud system are able to communicate with each other and to share information. The cloud system may manage parking reservations. The cloud system may manage the travel control authority of the vehicle 100. The cloud system may manage parking lot information.

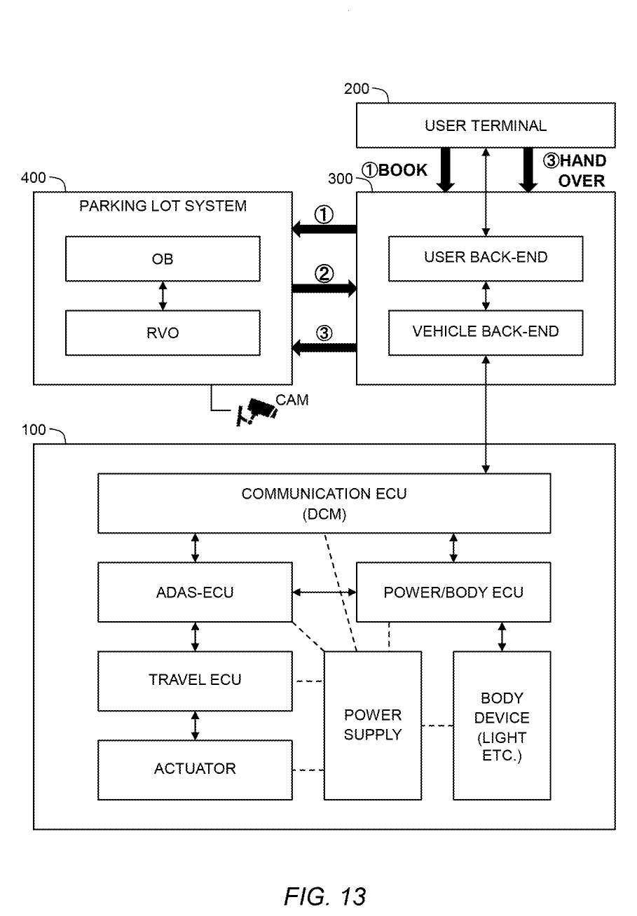

FIGS. 13 to 18 are block diagrams for explaining an example of processing in the AVP system 10. Initially, a communication between the vehicle 100 and the parking lot system 400 of the target parking lot is not established. Meanwhile, the back-end system 300 is able to communicate with the vehicle 100, the user terminal 200, and the parking lot system 400.

FIG. 13 illustrates a reservation phase and a check-in phase.

(1) The user of the vehicle 100 operates the user terminal 200 to make a reservation of the use of the AVP in the target parking lot. The user terminal 200 sends a reservation request to the back-end system 300 (the user back-end). The back-end system 300 (the user back-end) accepts the reservation. Moreover, the back-end system 300 provides the reservation information to the parking lot system 400. The parking lot system 400 manages the AVP of the vehicle 100 of the user in the target parking lot.

(2) The vehicle 100 (the target vehicle) driven by the user arrives at the entry area of the target parking lot. The parking lot system 400 uses the infrastructure camera to recognize that the vehicle 100 has arrived at the entry area. The user gets off the vehicle 100 and requests the AVP start. The parking lot system 400 notifies the back-end system 300 of the user's check-in.

(3) The user uses the user terminal 200 to perform a handover operation to transfer the operation authority of the vehicle 100. The user terminal 200 sends a handover request to the back-end system 300. The back-end system 300 notifies the parking lot system 400 of the handover.

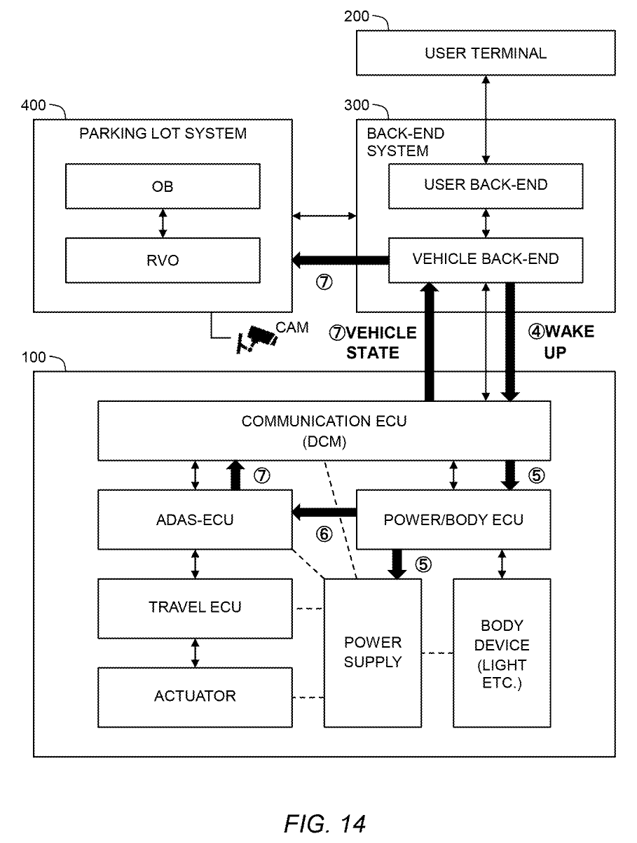

FIG. 14 illustrates a vehicle activation (wake-up) phase.

(4) The back-end system 300 (the vehicle back-end) transmits a wake-up request to the vehicle 100 (the target vehicle). The communication ECU of the vehicle 100 receives the wake-up request from the back-end system 300. It should be noted that the communication ECU and the power/body ECU are in standby states even when the power supply of the vehicle 100 is turned OFF.

(5) In response to the wake-up request, the communication ECU transmits an activation command to the power/body ECU. The power/body ECU turns ON the power supply of the vehicle 100. As a result, the ADAS-ECU, the travel ECU, and the like are activated.

(6) The power/body ECU transmits information on the power supply state (i.e., activation completed) to the ADAS-ECU.

(7) The ADAS-ECU transmits information on the vehicle state including the power supply state to the communication ECU. The communication ECU transmits the vehicle state information to the back-end system 300 (i.e., the vehicle back-end). The back-end system 300 (i.e., the vehicle back-end) transmits the vehicle state information to the parking lot system 400.

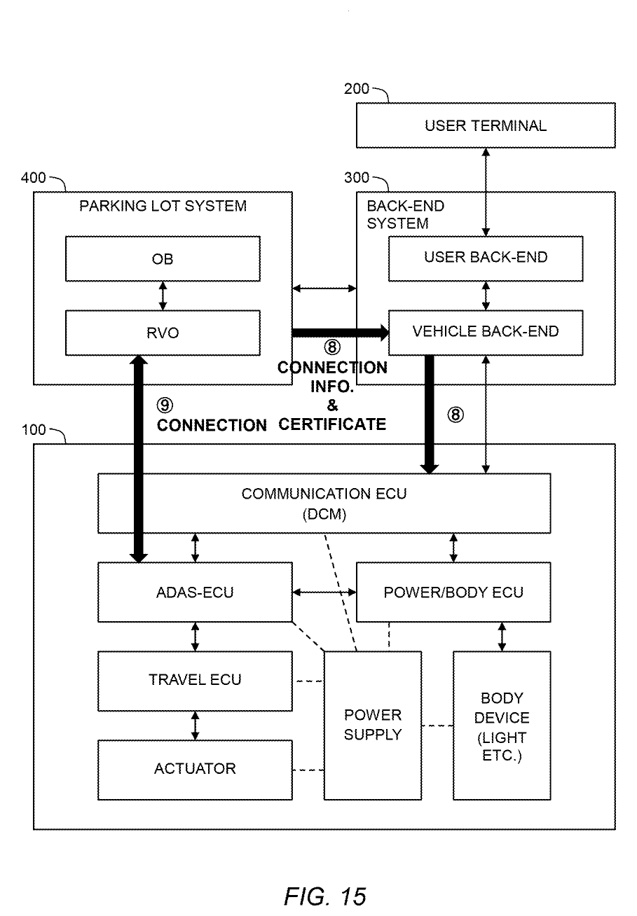

FIG. 15 illustrates a communication connection phase.

(8) The parking lot system 400 transmits the connection information of the target parking lot to the back-end system 300 (the vehicle back end). The connection information includes the SSID and the like of the parking lot system 400. Further, the parking lot system 400 transmits the second parking lot certificate for the mutual authentication to the back-end system 300 (the vehicle back-end). The back-end system 300 (the vehicle back-end) transmits the connection information and the second parking lot certificate to the vehicle 100. The communication ECU of the vehicle 100 receives the connection information and the second parking lot certificate. The communication ECU stores the second parking lot certificate in the secure area MEM-S (specifically, the second memory MEM-2).

(9) The communication ECU of the vehicle 100 requests the parking lot system 400 of the target parking lot to establish a communication connection based on the connection information (the SSID). The communication ECU of the vehicle 100 and the RVO of the parking lot system 400 perform the mutual authentication based on the certificates. The mutual authentication is as described in the above Section 2. Through the mutual authentication, the communication between the communication ECU of the vehicle 100 and the RVO of the parking lot system 400 is established. As a result, the communication is established between the ADAS-ECU of the vehicle 100 and the RVO of the parking lot system 400. Moreover, the vehicle 100 and the parking lot system 400 monitor a communication state with each other.

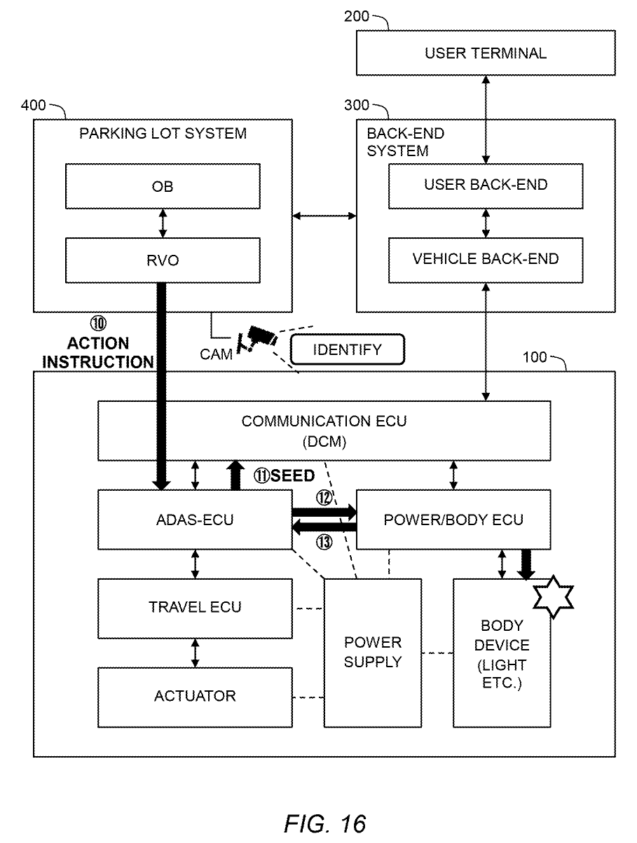

FIG. 16 illustrates a vehicle identification phase.

(10) The parking lot system 400 (the RVO) instructs the vehicle 100 to perform a predetermined action. An action is defined by a combination of a device that executes the action and an operation pattern of the device. Examples of a visible action include turning on a light, flashing a light, flashing a blinker, operating a wiper, opening and closing a door, opening and closing a window, opening and closing a door mirror, opening and closing an engine hood, and so forth. Examples of an audible action include sounding a horn, driving an engine, and so forth. For example, a head light or a blinker flashes in a predetermined pattern for a predetermined period of time (e.g., several seconds). As another example, a door mirror may open and close in a predetermined pattern for a predetermined period of time. As yet another example, the horn may sound in a predetermined pattern for a predetermined period of time. The action of a predetermined pattern may be executed repeatedly in time. The parking lot system 400 (the RVO) transmits, to the vehicle 100, an action instruction that instructs to execute the predetermined action. The predetermined action is, for example, flashing a blinker. The ADAS-ECU of the vehicle 100 receives the action instruction via the communication ECU.

(11) The action instruction transmitted from the parking lot system 400 to vehicle 100 may include seed information. The seed information is necessary for checksum verification of a time synchronization request, which will be described later. The ADAS-ECU of the vehicle 100 retrieves the seed information from the action instruction received from the parking lot system 400. Further, the ADAS-ECU transmits the seed information to the communication ECU. The communication ECU retains the seed information.

(12) In response to the action instruction, the ADAS-ECU instructs the power/body ECU to perform the predetermined action. The power/body ECU controls the body device to perform the predetermined action in accordance with the action instruction. For example, the power/body ECU flashes the blinker. The parking lot system 400 uses the infrastructure camera CAM or the like to recognize a vehicle that performs the predetermined action. The parking lot system 400 identifies a vehicle that has performed the predetermined action as the vehicle 100 (i.e., the target vehicle). The parking place system 400 localizes the vehicle 100 (i.e., the target vehicle).

(13) The power/body ECU transmits information indicating the state of the body device to the ADAD-ECU.

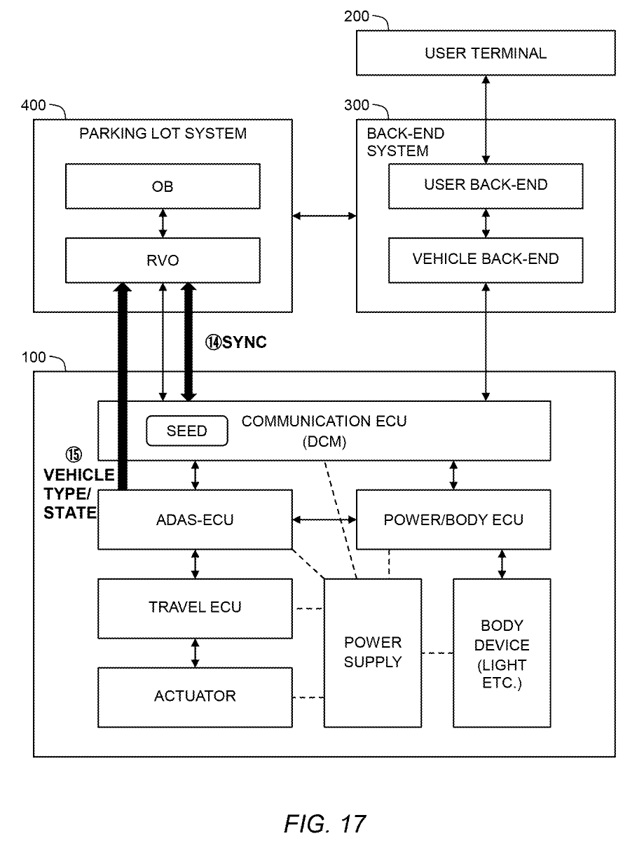

FIG. 17 illustrates a time synchronization phase.

(14) The parking lot system 400 (the RVO) transmits a time synchronization request to the vehicle 100. The communication ECU of the vehicle 100 receives the time synchronization request transmitted from the parking lot system 400. The communication ECU verifies the time synchronization request received from the parking lot system 400, in order to verify certainty of the communication between the parking lot system 400 and the vehicle 100. More specifically, the communication ECU verifies the time synchronization request by utilizing a publicly-known error detection method. For example, a publicly-known cyclic redundancy check (CRC) is utilized for the error detection. The verification of the time synchronization request through such the error detection is hereinafter referred to as "checksum verification" for convenience. As described above, the communication ECU already retains the seed information necessary for the checksum verification. The communication ECU performs the checksum verification with respect to the time synchronization request by using the seed information. When an error in the time synchronization request is detected as a result of the checksum verification, the communication ECU notifies the parking lot system 400 of the error. Moreover, the communication ECU processes the time synchronization request and generates a time synchronization response. The time synchronization response includes a value of a vehicle clock as a vehicle time stamp. Then, the communication ECU returns the time synchronization response to the parking lot system 400. Since the communication ECU, not the ADAS-ECU, performs the checksum verification and returns the time synchronization response, it is possible to reduce a time from when the vehicle 100 receives the time synchronization request to when the vehicle 100 returns the time synchronization response.

(15) The ADAS-ECU of the vehicle 100 transmits information indicating a type and a state of the vehicle 100 to the parking lot system 400 via the communication ECU.

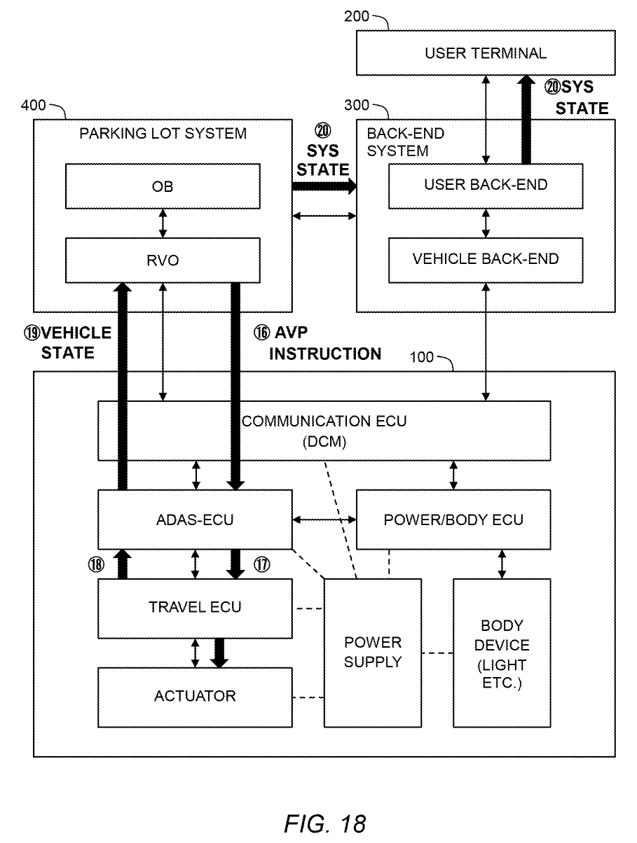

FIG. 18 illustrates an AVP execution phase.

(16) The parking lot system 400 (the RVO) transmits an AVP instruction to the vehicle 100. The ADAS-ECU of the vehicle 100 receives the AVP instruction via the communication ECU. In response to the AVP instruction, the ADAS-ECU generates a travel plan and calculates a control amount for realizing the travel plan.

(17) The ADAS-ECU transmits a travel control instruction including the calculated control amount to the travel ECU. The travel ECU controls the actuator in accordance with the travel control instruction. As a result, the vehicle 100 automatically travels toward the destination.

(18) The travel ECU notifies the ADAS-ECU of information on the vehicle travel state.

(19) The ADAS-ECU transmits information on the vehicle state including the vehicle travel state to the parking lot system 400 (the RVO) via the communication ECU.

(20) The parking lot system 400 transmits information on a system state including the vehicle state to the back-end system 300. The back-end system 300 (the user back-end) transmits the information on the system state to the user terminal 200.

What is claimed is:

1. A vehicle having an automated valet parking function, wherein
a target parking lot is a parking lot used by the vehicle,
a parking lot system is configured to manage automated valet parking in the target parking lot,
the automated valet parking of the vehicle in the target parking lot requires a wireless communication between the vehicle and the parking lot system,
the parking lot system retains a first parking lot certificate that is a certificate of the parking lot system itself and is necessary for mutual authentication between the vehicle and the parking lot system, and
a back-end system managing the vehicle is capable of communicating with the vehicle,
the vehicle comprising processing circuitry, wherein
the processing circuitry is configured to:
acquire a second parking lot certificate from the back-end system via communication, the second parking lot certificate being associated with the first parking lot certificate and being necessary for verifying the first parking lot certificate;
retain the second parking lot certificate acquired from the back-end system; and
when performing the mutual authentication with the parking lot system for establishing the wireless communication, receive the first parking lot certificate from the parking lot system and verify the first parking lot certificate by using the second parking lot certificate.

2. The vehicle according to claim 1, wherein
the second parking lot certificate is not preinstalled in the vehicle.

3. The vehicle according to claim 1, wherein
the processing circuitry is further configured to acquire the second parking lot certificate from the back-end system in conjunction with a reservation of the automated valet parking in the target parking lot or activation of the vehicle in the target parking lot.

4. The vehicle according to claim 1, wherein
the second parking lot certificate is an intermediate certificate.

5. The vehicle according to claim 1, wherein
the processing circuitry is further configured to delete the second parking lot certificate after the vehicle finishes using the target parking lot.

6. The vehicle according to claim 1, wherein
the processing circuitry is further configured to change a period for retaining the second parking lot certificate according to a frequency of use of the target parking lot by the vehicle.

7. The vehicle according to claim 1, wherein
the processing circuitry is further configured to:
retain a first vehicle certificate that is a certificate of the vehicle and is necessary for the mutual authentication between the vehicle and the parking lot system; and
when performing the mutual authentication with the parking lot system, present the first vehicle certificate to the parking lot system.

8. The vehicle according to claim 7, further comprising:
a first memory configured to store the first vehicle certificate; and
a second memory configured to store the second parking lot certificate.

9. The vehicle according to claim 8, wherein
a security level of the first memory is higher than a security level of the second memory.

10. A back-end system capable of communicating with a vehicle having an automated valet parking function, wherein
a target parking lot is a parking lot used by the vehicle,
a parking lot system is configured to manage automated valet parking in the target parking lot,
the automated valet parking of the vehicle in the target parking lot requires a wireless communication between the vehicle and the parking lot system, and
the parking lot system retains a first parking lot certificate that is a certificate of the parking lot system itself and is necessary for mutual authentication between the vehicle and the parking lot system,
the back-end system comprising processing circuitry, wherein
the processing circuitry is configured to provide the vehicle with a second parking lot certificate via communication, the second parking lot certificate being associated with the first parking lot certificate and being necessary for verifying the first parking lot certificate, and
when performing the mutual authentication between the vehicle and the parking lot system for establishing the wireless communication, the vehicle receives the first parking lot certificate from the parking lot system and verifies the first parking lot certificate by using the second parking lot certificate.

11. An automated valet parking system comprising:
a vehicle having an automated valet parking function; and
a back-end system that manages the vehicle and is capable of communicating with the vehicle, wherein
a target parking lot is a parking lot used by the vehicle,
a parking lot system is configured to manage automated valet parking in the target parking lot,
the automated valet parking of the vehicle in the target parking lot requires a wireless communication between the vehicle and the parking lot system,
the parking lot system retains a first parking lot certificate that is a certificate of the parking lot system itself and is necessary for mutual authentication between the vehicle and the parking lot system,
the back-end system is configured to provide the vehicle with a second parking lot certificate via communication, the second parking lot certificate being associated with the first parking lot certificate and being necessary for verifying the first parking lot certificate,
the vehicle is configured to retain the second parking lot certificate acquired from the back-end system; and
when performing the mutual authentication with the parking lot system for establishing the wireless communication, the vehicle is configured to receive the first parking lot certificate from the parking lot system and to verify the first parking lot certificate by using the second parking lot certificate.
